(19) United States
(12) Patent Application Publication
(10) Pub. No.: US 2018/0107987 A1
(43) Pub. Date: Apr. 19, 2018

(54) MEETING SERVICE WITH MEETING TIME AND LOCATION OPTIMIZATION

(71) Applicant: MICROSOFT TECHNOLOGY LICENSING, LLC, Redmond, WA (US)

(72) Inventors: Mark Daniel MacKenzie, Seattle, WA (US); Hiroshi Tsukahara, Bellevue, WA (US); Sebastian Bengochea, Sammamish, WA (US); Philipp Cannons, Seattle, WA (US)

(73) Assignee: MICROSOFT TECHNOLOGY LICENSING, LLC, Redmond, WA (US)

(21) Appl. No.: 15/294,071

(22) Filed: Oct. 14, 2016

(51) Int. Cl. G06Q 10/10; G06Q 10/06; G06F 17/30

(52) U.S. Cl. CPC G06Q 10/1095; G06F 17/3053; G06Q 10/063116

(57) ABSTRACT

A meeting service with meeting time and location optimization is described. In some examples, organizer and attendee behaviors may be analyzed and used as contextual factors in computing ranking scores for potential meeting times. To optimize a meeting for the attendees (including the organizer), potential meeting times and locations may be ranked based on weighted coefficients for the factors that are used in ranking such as attendee schedules, preferences, meeting type, location attributes, attendee preferences for locations, and extraneous factors such as events and other happenings that may impact availability or access of attendees as well as meeting locations.

### BACKGROUND

When an organizer is setting up a meeting with a number of attendees, it may be challenging to try to determine a time that may work well for all the attendees. A meeting organizer typically needs to consider his or her own availability and the availability of each of the attendees. In addition, the organizer may often consider other more abstract factors, such as working hours, preferences around meeting in the morning or afternoon, avoiding lunch hours, travel logistics, and so forth. Taking these factors into consideration may take substantial time and effort, and still leave the organizer unsure whether he or she has found a suitable time for the meeting or not.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a meeting service with meeting time and location optimization. In some examples, a meeting request may be received, where the meeting request includes a list of attendees and an indication of meeting content. Availability and contextual information associated with an organizer and the attendees of the requested meeting may be retrieved from one or more resources. Information associated with one or more extraneous factors with a potential impact on the requested meeting may also be retrieved from other resources. A set of potential meeting times and a set of meeting rooms may be determined and ranked based on the availability, the contextual information, and the one or more extraneous factors. The set of potential meeting times and the set of meeting rooms or a top ranked one of the set of potential meeting times and the set of meeting rooms may be provided to be displayed for confirmation or selection by the organizer and/or the attendees.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes an example network environment where a meeting service with meeting time and location optimization may be implemented;

FIG. 2 illustrates conceptually meeting time and location optimization in a hosted service environment;

FIG. 3 illustrates example resources employed in meeting time and location optimization by a scheduling engine:

FIG. 4 illustrates an example user interface for organizing a meeting with meeting time and location optimization;

FIG. 5 illustrates an example user interface for location, selection in conjunction with a meeting service with meeting time and location optimization;

FIG. 6 illustrates another example user interface for location selection in conjunction with a meeting service with meeting time and location optimization;

FIG. 7 is a networked environment, where a system according to embodiments may be implemented;

FIG. 8 is a block diagram of an example general purpose computing device, which may be used to provide a meeting service with meeting time and location optimization; and

FIG. 9 illustrates a logic flow diagram of a method to provide meeting time and location optimization.

### DETAILED DESCRIPTION

As briefly described above, embodiments are directed to a meeting service with meeting time and location optimization. In some examples, organizer and attendee behaviors may be analyzed and used as contextual factors in computing ranking scores for potential meeting times. To optimize a meeting for the attendees (including the organizer), potential meeting times and locations may be ranked based on weighted coefficients for the factors that are used in ranking such as attendee schedules, preferences, meeting type, location attributes, attendee preferences for locations, and extraneous factors such as events and other happenings that may impact availability or access of attendees as well as meeting locations. Learning based computations may utilize feedback to enhance accuracy of meeting time and location selections for future meetings.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that ate linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing a meeting service with meeting time and location optimization. Examples of platforms include, but are not limited to a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

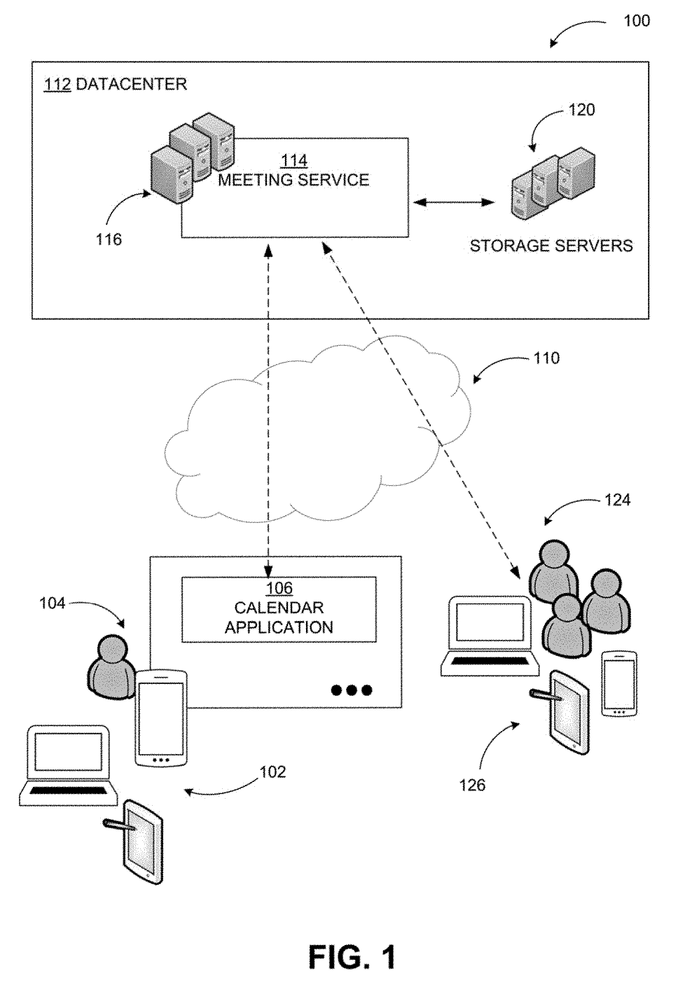

FIG. 1 includes an example network environment where a meeting service with meeting time and location optimization may be implemented.

As illustrated in diagram 100, an example system may include a datacenter 112 hosting a cloud-based meeting service 114 configured to provide a number of services such as scheduling meetings, facilitating online meetings, and others that may be accessed across multiple devices and users. The datacenter 112 may include one or more processing servers 116 configured to execute the meeting service 114, among other components. In some embodiments, at least one of the processing servers 116 may be operable to manage the meeting service 114, where data associated with the provided services to and from devices (such as devices 122, 126) may be stored at storage servers 120 (or associated data stores). As described herein, the meeting service 114 may be implemented as software, hardware, or combinations thereof.

In some embodiments, the meeting service 114 may be configured to interoperate with various applications to provide the specific services. For example, as illustrated in the diagram 100, a user 104 may execute a thin (e.g., a web browser) or a thick (e.g., a locally installed client application) version of a calendar application 106 through the device 102 with which the meeting service 114 may be configured to integrate and interoperate with over one or more networks, such as network 110. The calendar application 106 may be an application hosted by the meeting service, or part of a combination of applications such as a communication application that enables various modes of communication in addition to managing calendars and facilitating meetings, for example. The device 102 may include a desktop computer, a laptop computer, a tablet computer, a vehicle mount computer, a smart phone, or a wearable computing device, among other similar devices. A communication interlace may facilitate communication between the meeting service 114 and the calendar application 106 over the network 110.

The meeting service 114 may be a subscription based service, that is, each user may have an account and access the services by logging in to their account using a password, for example. According to some embodiments, a server-side module of the meeting service 114 may suggest possible meeting times to a meeting organizer, taking into account a history and preferences of the organizer and designated meeting attendees, along with other contextual and extraneous information. The suggestions presented to the organizer may align closely with suitable meeting times he or she may deter mine if they went through the customary process of considering a variety of factors themselves. Taking into account subtler contextual information, and tracking and leveraging a history and preferences of the meeting organizer and attendees, faster, more efficient meeting time decisions may be made.

Contextual factors and extraneous information feat may be taken into consideration may include, but are not limited to, a history of the meeting organizer and/or meeting attendees of accepting certain meetings, preferring certain times/locations, meeting schedules, workloads, future availabilities, weather forecast, a convention causing worse than normal traffic or affecting availability of accommodations, meeting places, etc.

The technical advantages of providing meeting time and location optimization may include, among others, increased efficiency in user interaction and data management, reduced processing and network bandwidth usage, and improved user interaction by allowing users to quickly select meeting times without back and forth, communication with attendees.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of devices and users storing and/or sharing content both locally at client devices and remotely at cloud-based storage services.

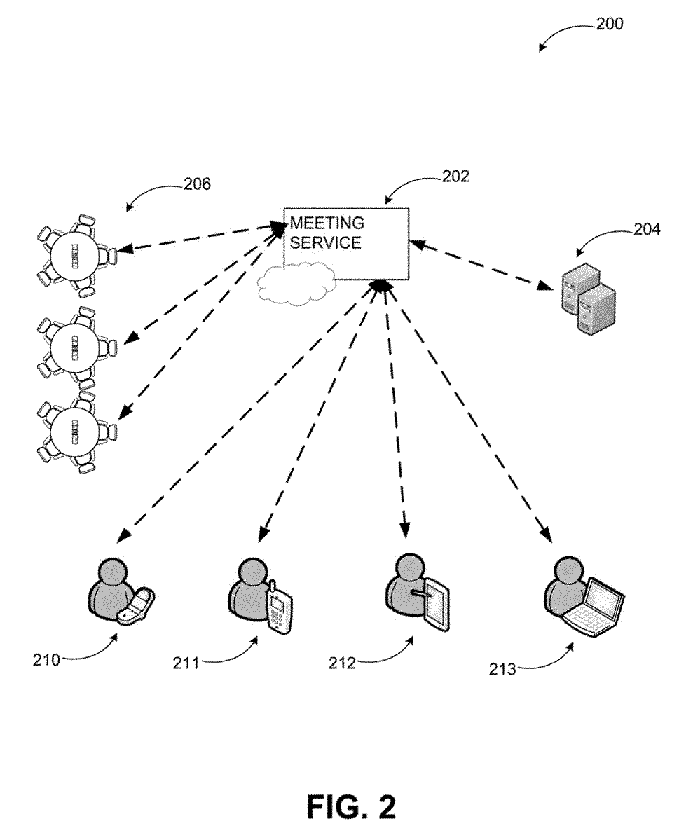

FIG. 2 illustrates conceptually meeting time and location optimization in a hosted service environment.

As shown in diagram 200, the meeting service 202 may collect/retrieve contextual information associated with users 210-213 and use the contextual information to rank potential meeting times in order to determine an optimal meeting time for the attendees of a requested meeting in addition to the attendees' schedules. The contextual information may be received from a variety of applications and services associated with the users 210-213 such as calendar applications, communication applications, a directory service, personal or professional networking services, and comparable ones.

To determine a suitable meeting location, the meeting service 202 may collect/retrieve information associated with meeting rooms 206 (or other suitable locations). The meeting room location and availability information may be used in conjunction with attendee contextual information such as use frequency, attendee locations, attendee preferences, and so on to rank the meeting rooms in order to determine an optimal meeting place. The suggested meeting place(s) may be presented along with ranked potential meeting times to the attendees/organizer for selection. Furthermore, extraneous information may be collected from a variety of sources such as server 204. The extraneous information may include factors such as traffic, weather conditions, and similar ones that may impact the desired meeting.

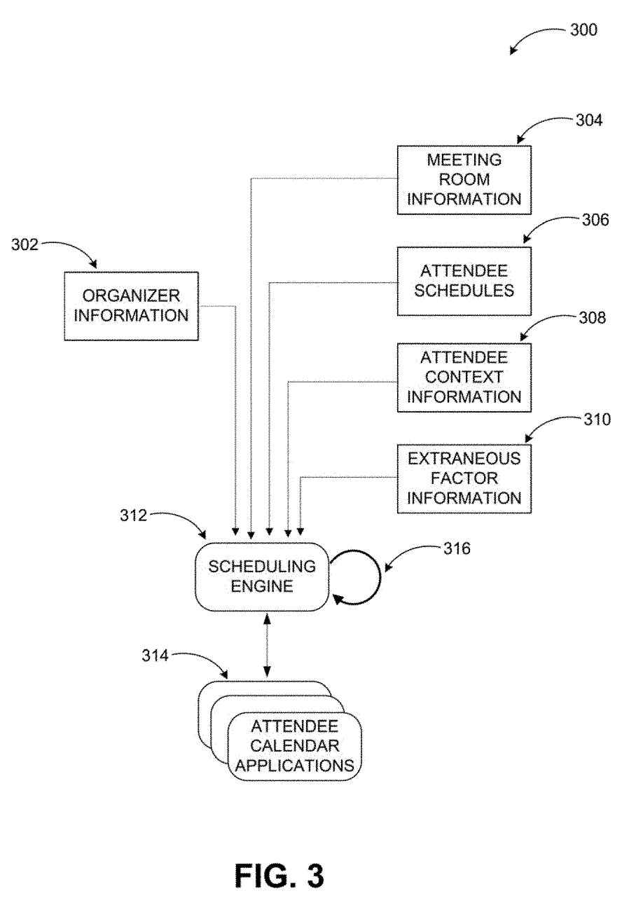

FIG. 3 illustrates example resources employed in meeting time and location optimization by a scheduling engine.

As shown in diagram 300, a scheduling engine 312 of a meeting service may receive one or more of organize information 302, meeting room information 304, attendee schedules 306, attendee contextual information 308, and extraneous factor information 310. The scheduling engine 312 may employ a ranking system for potential meeting times and/or meeting rooms based on the received information to determine a ranked list of potential meeting times and/or available meeting rooms and to present them to the organize and the attendees through their respective calendar applications 314. Some of the information may also be received from the calendar applications 314. The ranking process 316 may be an iterative one.

The ranking system may determine patterns in the users' behaviors. The patterns may be used toward mimicking the users' behavior in planning upcoming meetings with other users. Given a list of viable time slots (that are available to all attendees), the applicable time slots may be ranked based on the likelihood of being selected for a requested meeting. To increase the likelihood of recall (the user selects from the suggestions list) and to increase precision (the user selects the fop ranked suggestion in the ranked list), optimal values for weights that each of a number of functions' distributions may have that reflect on the final ranking score may be determined given coefficients associated with each of the computed functions. A machine learning or similar approach may include a measure of success, which may be based on prior knowledge of users' behavioral patterns and indicated maximized recall and precision. Furthermore, with the calculated weights, insight may be gained on which functions and possible features contribute more toward the ranking computations and steer the direction toward future function exploration and user personalization.

Following is an example of how scores for ranking potential meeting times may be computed. The example formula is for illustration purposes. Other computation methods may be employed using the principles described herein.

SC(tsⱼ)=Σᵢ₌₀ⁿSfhd i(tsⱼ)*Kᵢ(Kᵢ=1∀i∈[0,n])

where tsⱼ represents the time slot j to compute the score for; SC is the score calculating junction, for a given time slot tsⱼ; Sfᵢ represents the score function i to return the score value (n functions total); and Kᵢ is the coefficient used associated to function fᵢ. The coefficients maybe estimated using a number of approaches such as brute force, greedy optimization, simulated annealing, and others.

As discussed above, various factors in ranking potential meeting times and/or potential meeting rooms may be weighted. A success measure may be used to confirm suitable weight values in an iterative process. The success measure may be based on recall and precision as discussed above. Recall may be defined as follows:

1. Time slot m is within the M list

2. Variable suggestions threshold is: Time slot m is within the top t of the M list, where t is the threshold, t ∈ [10→3] (10 and 3 example values)

This variable threshold may provide an insight on how many suggestions should be shown to the user and a likelihood of the user selecting one of the top t suggestions. The ranker module may be repeatedly retrained based on users+ selections.

In some examples, precision may be computed as follows:
Best case: The user's selection=top ranked suggestion:
   SC(tsₘ)=Max(SC(tsⱼ) ∀ j ∈ [1,M])
Worst case: The user's selection=least ranked suggestion:
   SC(tsₘ)=Min(SC(tsⱼ) ∀ j ∈ [1,M])

### Thus,

$$Precision ( {ts}_{m} ) = 1 - \frac{Max ( SC ( ts ) ) - SC ( {ts}_{m} )}{Max ( SC ( ts ) ) - Min ( SC ( ts ) )}$$

As mentioned above, a number and type of specific factors, weights and weighting method, ranking approach, and computations may be adjusted depending on specific situations, service environment, users, and so on using the principles discussed herein.

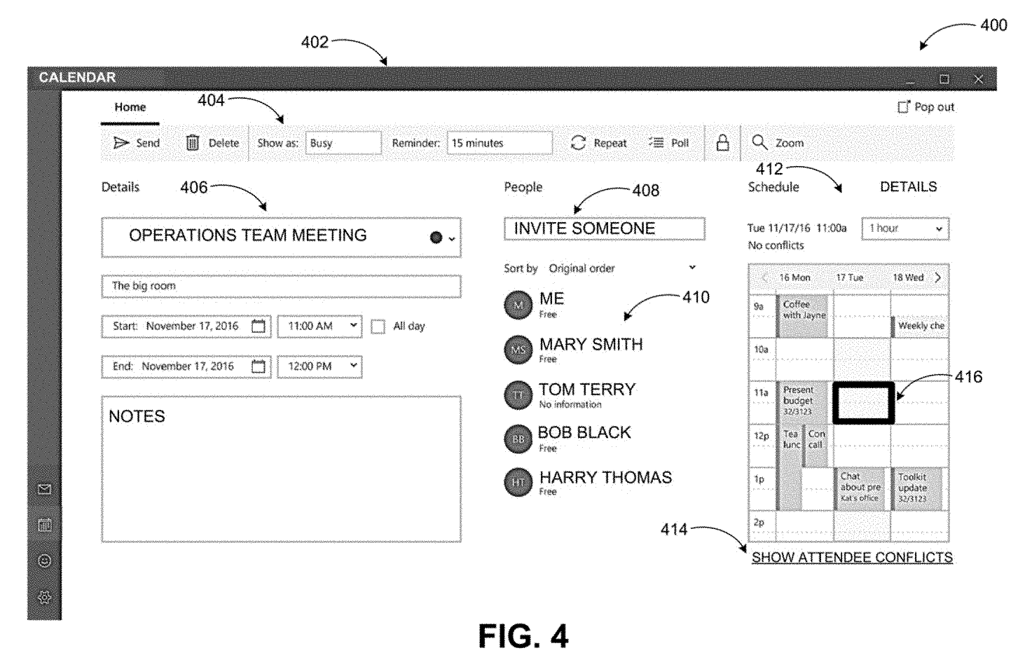

FIG. 4 illustrates an example user interface for organizing a meeting with meeting time and location optimization.

Meeting organization user interlace 402 in diagram 400 includes meeting related control 404 such as how to categorize the meeting, whether it will recur, reminder settings, etc. Meeting details 406 may include a title for the meeting, a meeting room selection (or suggestion), meeting time, date, and notes. Attendees may be invited through invitation control 408 and current invitees 410 may be listed with contextual information such as their availability and/or other presence information. A schedule preview 412 may display suggested meeting time(s) 416 within the organizer's schedule to provide the organizer a context within his or her overall schedule. Optionally, a control 414 may be. provided to show attendee conflicts on the schedule preview 412. While the user interface 402 displays information for the organizer of the meeting, other attendees may see similar information on their user interfaces such as who is organizing, who are invited, etc.

a system according to embodiments, the meeting time and/or the meeting location may be suggested by the meeting service based on a ranking of potential meeting times and meeting rooms taking contextual factors and extraneous factors into consideration. In some examples, multiple meeting times or meeting rooms may be suggested for selection by the organizer (or an attendee).

In some examples, working hours of a user that are to be calculated, may be assumed to be the user's most “active hours” as tar as attending meetings is concerned. The “working hours” (different from work hours such as 8.00 am to 5.00 pm) may be determined fey finding the times at which a substantial number of meetings are attended by the user for the past 3 months, for example (or any predefined period). The number of meetings that a user has attended at a particular time of day may be collected over the predefined period. For example, a user may have attended 4 meetings between 8:30 am and 9.00 am on Monday and 40 meetings between 9.00 am and 9:30 am on Monday. The sharp increase in meetings around 9.00 am may indicate that the user's working hours start around 9.00 am on Monday. The user's working hours may be determined for every day of the week. Weekends may be considered working days and working hours for those days may be determined too, because weekends may be considered as working days in certain geographies.

In otter examples, meetings may be scored according to their importance, which may be quantified by a number of people attending, the attendees' level within an organization or in relation to the organizer. Separate “working hours” distribution may be constructed for every person with a specific person against time of day allowing suggestions to be customized to a specific person. Attendance history of the attendees max be considered against time of day or day of week. Importance of individual attendees may also be considered in order to suggest meeting times such that more important attendees (e.g., software designer for a design meeting, marketing person for a marketing review meeting, etc.) availability is weighted higher compared to other factors (as opposed to conventional “required” and “optional” categories).

In other examples, meetings may be scored according to their importance, which may be quantified by a number of people attending, the attendees' within an organization or in relation to the organizer. Separate “working hours” distribution may be constructed for every person with a specific person against time of day allowing suggestions to be customized to a specific person. Attendance history of the attendees may be considered against time of day or day of week. Importance of individual attendees may also he considered in order to suggest meeting times such that more important attendees (e.g., software designer for a design meeting, marketing person for a marketing review meeting, etc.) availability is weighted higher compared to other factors (as opposed to conventional “required” and “optional” categories).

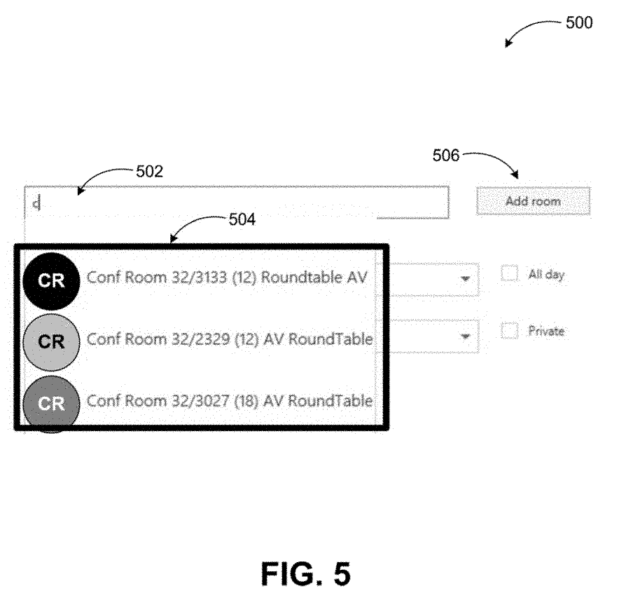

FIG. 5 illustrates an example user interface for location selection in conjunction with a meeting service with meeting time and location optimization.

As shown, in diagram 500, a user interface for scheduling a meeting may include a meeting room selection user interface component. Upon activation of an Add room control 506 and/or typing into an input box 502 may trigger suggestion of available meeting rooms 504.

In a system according to embodiments, the suggested meeting rooms may be selected based on a ranking. Thus, the top listed meeting room may be the one with the highest ranking score, etc. The ranking may take into account, contextual factors such as those discussed above in conjunction with meeting time ranking and selection. In addition, a use frequency may be used for the meeting rooms (that is, a meeting room most frequently used by one or more attendees may be given a higher score). In some examples, a time decay may be applied to the frequency of use factor. Heuristics may also be used to rank meeting rooms.

In one example, one or more meeting rooms may be physically closer to the attendees of a requested meeting than another meeting room (for example, in the same building or on the same floor as the attendees). However, the meeting may be late in the afternoon, and a majority of the attendees may desire to meet in a room closer to a parking garage. Thus, while selecting the other meeting room farther away from the physical locations of the attendees may fee counter-intuitive, a system according to embodiments, may take the contextual factors such as time of day and user behavior into consideration and suggest the other meeting room instead of the closer ones.

As in the meeting time determination, attendee actions such as rejection of the meeting room or suggestion of alternative meeting room(s) to the organizer may be recorded and used to enrich ranker module training data. In some embodiments, the ranker module may be trained online and offline through a machine learning mechanism.

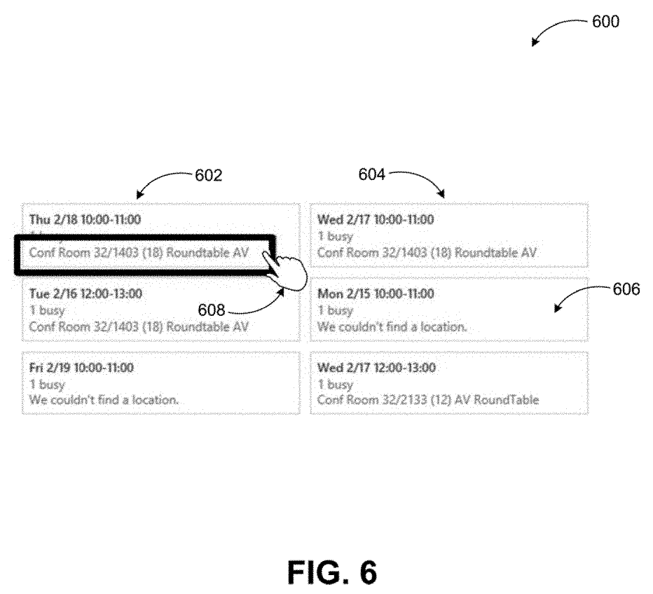

FIG. 6 illustrates another example user interface for location selection in conjunction with a meeting service with meeting time and location optimization.

Diagram 600 shows an alternative user interface for suggesting meeting rooms, in the example user interface, potential meeting times are listed for an attendee (or organizer) to select such as meeting times 602, 604, and 606. A top-ranked meeting room for each potential meeting time may be listed along with the potential meeting times. For some meeting times, a suitable meeting room may not be found. Thus, as in example potential meeting time 606, the meeting room unavailability may be displayed.

In yet other examples, a user may be enabled to select 608 the suggested meeting room and see other available meeting rooms (for example, remaining meeting rooms in the ranked list). The user may also be enabled to select another meeting room or search for other meeting rooms through the selection in the particular meeting time option.

The examples provided in FIGS. 1 through 6 are Illustrated with specific systems, services, applications, modules, codes, and notifications. Embodiments are not limited to environments according to these examples. A meeting service with meeting time and location optimization may be implemented in environments employing fewer or additional systems, services, applications, engines, codes, and user experience configurations. Furthermore, the example systems, services, applications, modules, and notifications shown in FIG. 1 through 6 may be implemented in a similar manner with other values using the principles described herein.

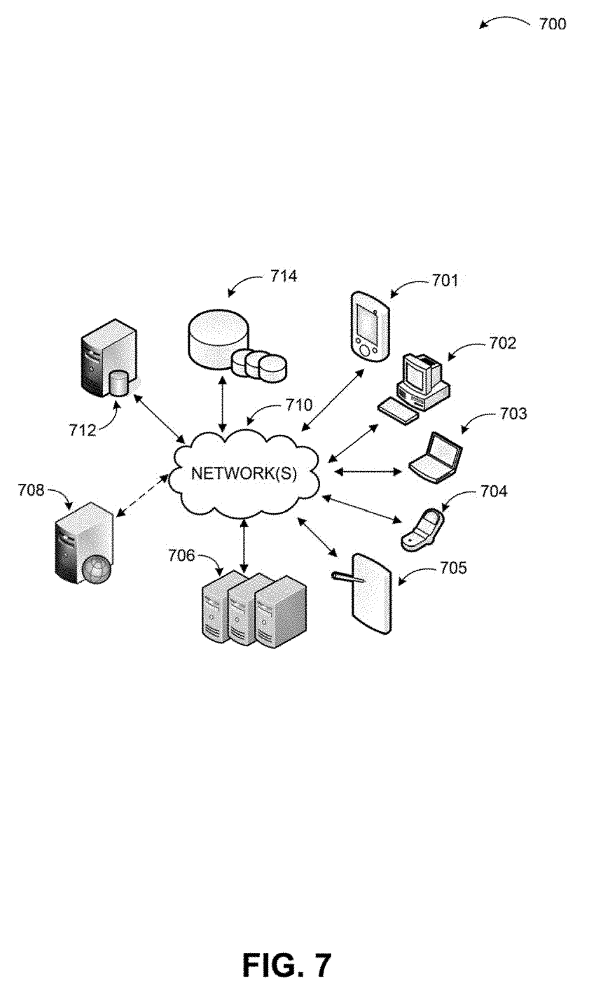

FIG. 7 is a networked environment, where a system according to embodiments may be implemented. In addition to locally installed applications (for example, application 107), a meeting service with meeting time and location optimization may also be employed in conjunction with hosted applications and services (for example, a service 114) that may be implemented via software executed over one or more servers 706, individual server 708, or at client devices, as illustrated in diagram 700. A hosted service or application may communicate with client applications on individual computing devices such as a handheld computer 701, a desktop computer 702, a laptop computer 703, a smart phone 704, a tablet computer (or slate), 705 (‘client devices’) through network(s) 710 and control a user interface presented to users.

Client devices 701-705 are used to access the functionality provided by the hosted service or application. One or more of the servers 706 or server 708 may be used to provide a variety of services as discussed above. Relevant data such as meeting data may be stored in one or more data stores (e.g. data store 714), which may be managed by any one of the servers 706 or by database server 712.

Network(s) 710 may comprise any topology of servers, clients, Interact service providers, and communication media. A system according to embodiments may have a static or dynamic topology. Network(s) 710 may include a secure network such as an enterprise network, an unsecure network such as a wireless open network, or the Internet. Network(s) 710 may also coordinate communication over other networks such as PSTN or cellular networks. Network(s) 710 provides communication between the nodes described herein. By way of example, and not limitation, network(s) 710 may include wireless media such as acoustic, RF, infrared and other wireless media.

Many other configurations of computing devices, applications, engines, data sources, and data, distribution systems may be employed for meeting time and location optimization. Furthermore, the networked environments discussed in FIG. 7 are for illustration purposes only. Embodiments are not limited to the example applications, engines, or processes.

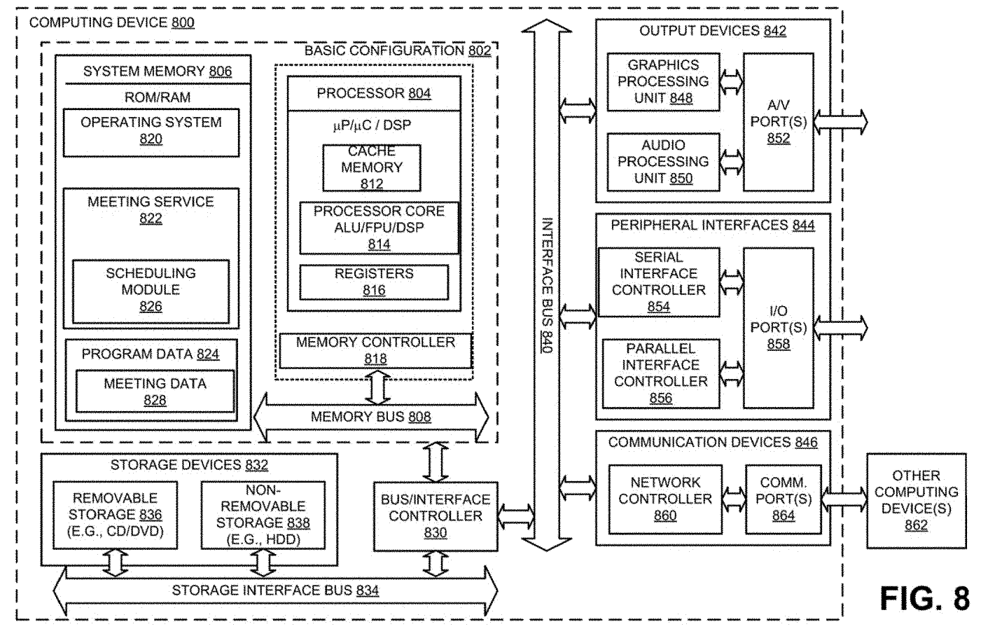

FIG. 8 is a block diagram of all example general purpose computing device, which may be used to provide a meeting service with meeting time and location optimization.

For example, computing device 800 may be used as a server, desktop computer, portable computer, smart phone, special purpose computer, or similar device. In an example basic configuration 802, the computing device 800 may include one or more processors 804 and a system memory 806. A memory bus 808 may be used for communicating between the processor 804 and the system memory 806. The basic configuration 802 is illustrated in FIG, 8 by those components within the inner dashed line.

Depending on the desired configuration, the processor 804 may be of any type, including but not limited to a microprocessor (μP), a microcontroller (μC), a digital signal processor (DSP), or any combination thereof. The processor 804 may include one more levels of caching, such as a level cache memory 812, one or more processor cores 814, and registers 816. The example processor cores 814 may (each) include an arithmetic logic unit (ALU), a floating point unit (FPU), a digital signal processing core (DSP Core), or any combination thereof. An example memory controller 818 may also be used with the processor 804, or in some implementations the memory controller 818 may be an internal part of the processor 804.

Depending on the desired configuration, the system memory 806 may be of any type including but not limited to volatile memory (such as RAM), non-volatile memory (such as ROM, flash memory, etc.) or any combination thereof. The system memory 806 may include an operating system 820, a meeting service 822, and program data 824. The meeting service 822 may include a. scheduling module 826, which may manage meeting time optimization and location optimization, and the like. The program data 824 may include, among other data, meeting data 828, as described herein.

The computing device 800 may have additional features or functionality, and additional interfaces to facilitate communications between the basic configuration 802 and any desired devices and interfaces. For example, a bus/interface controller 830 may be used to facilitate communications between the basic configuration 802 and one or more data storage devices 832 via a storage interface bus 834. The data storage devices 832 may be one or more removable storage devices 836, one or more non-removable storage devices 838, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data,

The system memory 806, the removable storage devices 836 and the non-removable storage devices 838 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 800. Any such computer storage media may be part of the computing device 800.

The computing device 800 may also include an interface bus 840 for facilitating communication from various interface devices (for example, one or more output devices 842, one or more peripheral interfaces 844, and one or more communication devices 846) to the basic configuration 802 via the bus/interface controller 830. Some of the example output de vices 842 include a graphics processing unit 848 and an audio processing unit 850, which may be configured to communicate to various external devices such as a display or speakers via one or more A/V ports 852. One or more example peripheral interfaces 844 may include a serial interface controller 854 or a parallel interlace controller 856, which may be configured to communicate with external devices such as input devices (for example, keyboard, mouse, pen, voice input device, touch input device, etc.) or other peripheral devices (for example, printer, scanner, etc.) via one or more I/O ports 858. An example communication device 846 includes a network controller 860, which may be arranged to facilitate communications with one or more other computing devices 862 over a network communication link via one or more communication ports 864. The one or more other computing devices 862 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information, delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF) microwave, infrared (IR) and other wireless media. The term computer readable media as used herein may include both storage media and communication media.

The computing device 800 may be implemented as a part of a general purpose or specialized server, mainframe, or similar computer that includes any of the above functions. The computing device 800 may also be implemented as a personal computer including both laptop computer and non-laptop computer configurations.

Example embodiments may also include methods to provide meeting time and location optimization. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by preselected criteria that may be machine automated.

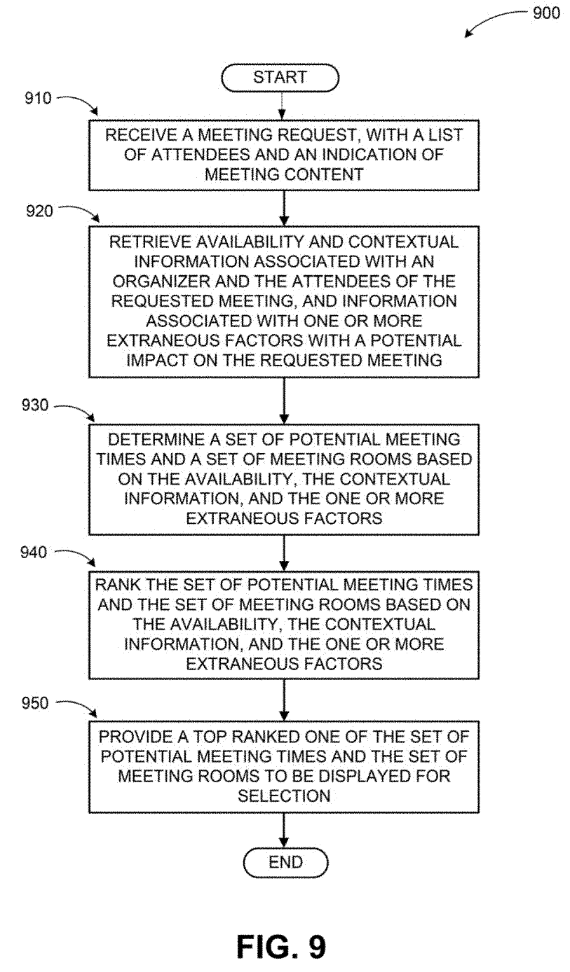

FIG. 9 illustrates a logic flow diagram of a method to provide meeting time and location optimization.

Process 900 may be implemented on a computing device, server, or other system. An example system may include a computer communicatively coupled to a cloud server hosting one or more components of a meeting service including a scheduling module.

Process 900 begins with operation 910, where a meeting request may be received with a list of attendees and an indication of meeting content. At operation 920, availability and contextual information associated with an organize and the attendees of the requested meeting as well as information associated with one or more extraneous factors with a potential impact on the requested meeting may be retrieved from one or more resources.

At operation 930, a set of potential meeting times and a set of meeting rooms may be determined based on the availability, the contextual information, and the one or more extraneous factors. At operation 940, the set of potential meeting times and the set of meeting rooms may be ranked based on the availability, the contextual information, and the one or more extraneous factors. At operation 950, the set of potential meeting times and the set of meeting rooms or a top ranked one of the set of potential meeting times and the set of meeting rooms may be provided to be displayed for confirmation or selection by the organizer and/or the attendees.

The operations included in process 800 are for illustration purposes. A meeting service with meeting time and location optimization may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for providing meeting time and location optimization is described. The means may include a means for receiving a meeting request, where the meeting request includes a list of attendees and an indication of meeting content; a means for retrieving availability and contextual information associated with an organizer and the attendees of the requested meeting a means for retrieving information associated with one or more extraneous factors with a potential impact on the requested meeting; a means for determining a set of potential meeting times and a set of meeting rooms based on the availability, and one or both of the contextual information and the one or more extraneous factors; and a means for providing a top ranked one of the set of potential meeting times and the set of meeting rooms to be displayed for confirmation.

According to some examples, a method executed at one or more computing devices to provide meeting time and location optimization is described. The method may include receiving a meeting request, wherein the meeting request includes a list of attendees and an indication of meeting content; retrieving availability and contextual information associated wife an organizer and the attendees of the requested meeting; retrieving information associated with one or more extraneous factors with a potential impact on the requested meeting; determining a set of potential meeting times and a set of meeting rooms based on the availability, and one or both of the contextual information and the one or more extraneous factors; and providing a top ranked one of the set of potential meeting times and the set of meeting rooms to be displayed for confirmation.

According to other examples, the method may further include ranking the set of potential meeting times and the set of meeting rooms based on the availability and one or both of the contextual information and the one or more extraneous factors; and providing the set of potential meeting times and die set of meeting rooms to he displayed for selection by the organizer or the attendees of the requested meeting. The method may also include determining patterns of behavior for the organizer and the attendees based on the contextual information; and determining and ranking the set of potential meeting times based on the determined patterns of behavior. Determining and ranking the set of potential meeting times based on the determined patterns of behavior may include increasing a recall and a precision, wherein the recall represents a likelihood of a selection of an actual meeting time among the set of potential meeting times and the precision represents a likelihood of a selection of a top ranked potential meeting time as the actual meeting time.

According to further examples, increasing the recall and the precision may include determining a plurality of factors based on the contextual information and the extraneous factors; assigning weight values to each of the plurality of factors; and determining the recall and the precision based on the weighted plurality of factors. Determining the set of meeting rooms may include taking into consideration a frequency of use of available meeting rooms by one or more of the organizer and the attendees. The method may also include applying a time decay to the frequency of use of the available meeting rooms. The extraneous factors may include one or more of a traffic condition, a weather condition, and a nearby event. The method may further include adjusting a plurality of factors to train a scheduling module configured to determine and to rank the set of potential meeting times and the set of meeting rooms based on a selection of an actual meeting time and an actual meeting room.

According to other examples, a computing device to provide meeting time and location optimization is described. The computing device may include a communication interface configured to facilitate communication between the computing device and other devices; a memory configured to store instructions; and one or more processors coupled to the memory, where the one or more processors, in conjunction with the instructions stored in the memory, are configured to execute a meeting service. The meeting service may include a calendar application; and a scheduling module configured to receive a meeting request, where the meeting request includes a list of attendees and an indication of meeting content; retrieve availability and contextual information associated with an organizer and the attendees of the requested meeting and information associated with one or more extraneous factors with a potential impact on the requested meeting; determine and rank a set of potential meeting times based on the availability and one or both of the contextual information and the one or more extraneous factors; and provide the ranked set of potential meeting times to be displayed for selection by the organizer or the attendees of the requested meeting.

According to some examples, the scheduling module may be further configured to determine a distribution of weighted available meeting times for the organizer and each of the attendees based on the availability, the contextual information, and the one or more extraneous factors. The scheduling module may be configured to determine the distribution of the weighted available meeting times based on an organizational position of each attendee in relation to the organizer. The scheduling module may be configured to determine the distribution of the weighted available meeting times based on a history of attendance of each attendee. The scheduling module may be configured to determine the distribution of the weighted available meeting times based on an attribute of each attendee in relation to a content of the requested meeting. The scheduling module may be further configured to determine and rank a set of potential meeting rooms based on the availability and one or both of the contextual. Information and the one or more extraneous factors; provide the ranked set of potential meeting rooms to be displayed for selection by the organizer or the attendees of the requested/meeting,

According to further examples, a method executed at one or more computing devices to provide meeting time and location optimization is described. The method may include receiving a meeting request, where the meeting request includes a list of attendees and an indication of meeting content; retrieving availability and contextual information associated with an organizer and the attendees of the requested meeting and information associated with one or more extraneous factors with a potential impact on the requested meeting; determining a plurality of factors based on the contextual information and the extraneous factors; assigning weight values to each of the plurality of factors; and determining a recall and a precision based on the weighted plurality of factors, wherein the recall represents a likelihood of a selection of an actual meeting time among the set of potential meeting times and the precision represents a likelihood of a selection of a top ranked potential meeting time as the actual meeting time; determining and ranking a set of potential meeting times based an increase of the recall and the precision; and providing the ranked set of potential meeting times to be displayed for selection by the organizer or the attendees of the requested meeting.

According to other examples, the method may further include determining a distribution of weighted available meeting times for the organizer and each of the attendees based on one or more communications associated with the organizer and each of the attendees. The method may also include analyzing the one or more communications to determine a likelihood of attendance. The one or more communications may include an email, a text message, a personal network posting, and a professional network posting. The method may also include determining a distribution of weighted available meeting times for the organizer and each of the attendees based on one or more one or more events on a schedule of the organizer and each of the attendees prior to and following a potential meeting time.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at one or more computing devices to provide meeting time and location optimization, the method comprising:
receiving a meeting request, wherein the meeting request includes a list of attendees and an indication of meeting content;
retrieving availability and contextual information associated with an organizer and the attendees of the requested meeting;
retrieving information associated with one or more extraneous factors with a potential impact on the requested meeting;
determining a set of potential meeting times and a set of meeting rooms based on the availability, and one or both of the contextual information and the one or more extraneous factors; and
providing a top ranked one of the set of potential meeting times and the set of meeting rooms to be displayed for confirmation.

2. The method of claim 1, further comprising:
ranking the set of potential meeting times and the set of meeting rooms based on the availability and one or both of the contextual information and the one or more extraneous factors; and
providing the set of potential meeting times and the set of meeting rooms to be displayed for selection by the organizer or the attendees of the requested meeting.

3. The method of claim 1, further comprising:
determining patterns of behavior for the organizer and the attendees based on the contextual information; and
determining and ranking the set of potential meeting times based on the determined patterns of behavior.

4. The method of claim 3, wherein determining and ranking the set of potential meeting times based on the determined patterns of behavior comprises:
increasing a recall and a precision, wherein the recall represents a likelihood of a selection of an actual meeting time among the set of potential meeting times and the precision represents a likelihood of a selection of a top ran ked potential meeting time as the actual meeting time.

5. The method of claim 4, wherein increasing the recall and the precision comprises:
determining a plurality of factors based on the contextual information and the extraneous factors;
assigning weight/values to each of the plurality of factors; and
determining the recall and the precision based oil the weighted plurality of factors,

6. The method of claim 1, wherein determining the set of meeting rooms comprises:
taking into consideration a frequency of use of available meeting rooms by one or more of the organizer and the attendees.

7. The method of claim 6, further comprising:
applying a time decay to the frequency of use of the available meeting rooms.

8. The method of claim 1, wherein the extraneous factors include one or more of a traffic condition, a weather condition, and a nearby event.

9. The method of claim 1, further comprising:
adjusting a plurality of factors to train a scheduling module configured to determine and to rank the set of potential meeting times and the set of meeting rooms based on a selection of an actual meeting time and an actual meeting room.

10. A computing device to provide meeting time and location optimization, the computing device comprising:
a communication interface configured to facilitate communication between the computing device and other devices;
a memory configured to store instructions; and
one or more processors coupled to the memory, wherein the one or more processors, in conjunction with the instructions stored in the memory, are configured to execute a meeting service, the meeting service comprising:
a calendar application; and
a scheduling module configured to:
receive a meeting request, wherein the meeting request includes a list of attendees and an indication of meeting content;
retrieve availability and contextual information associated with an organizer and the attendees of the requested meeting and information associated with one or more extraneous factors with a potential impact on the requested meeting;
determine and rank a set of potential meeting times based on the availability and one or both of the contextual information and the one or more extraneous factors; and
provide the ranked set of potential meeting times to be displayed for selection by the organizer or the attendees of the requested meeting.

11. The computing device of claim 10, wherein the scheduling module is further configured to:
determine a distribution of weighted available meeting times for the organizer and each of the attendees based on the availability, the contextual information, and the one or more extraneous factors.

12. The computing device of claim 11, wherein the scheduling module is configured to determine the distribution of the weighted available meeting times based on an organizational position of each attendee in relation to the organizer.

13. The computing device of claim 11, wherein the scheduling module is configured to determine the distribution of the weighted available meeting times based on a history of attendance of each attendee.

14. The computing device of claim 11, wherein the scheduling module is configured to determine the distribution of the weighted available meeting times based on an attribute of each attendee in relation to a content of the requested meeting.

15. The computing device of claim 10, wherein the scheduling module is further configured to:
determine and rank a set of potential meeting rooms based on the availability and one or both of the contextual information and the one or more extraneous factors;
provide the ranked set of potential meeting rooms to be displayed for selection by the organizer or the attendees of the requested meeting.

16. A method executed at one or more computing devices to provide meeting time and location optimization. the method comprising:
receiving a meeting request, wherein the meeting request includes a list of attendees and an indication of meeting content;
retrieving availability and contextual information associated with an organizer and the attendees of the requested meeting and information associated with one or more extraneous factors with a potential impact on the requested meeting;
determining a plurality of factors based on the contextual information and the extraneous factors;
assigning weigh to values to each of the plurality of factors;
determining a recall and a precision based on the weighted plurality of factors, wherein the recall represents a likelihood of a selection of an actual meeting time among the set of potential meeting times and the precision represents a likelihood of a selection of a top ranked potential meeting time as the actual meeting time;
determining and ranking a set of potential meeting times based an increase of the recall and the precision; and
providing the ranked set of potential meeting times to be displayed for selection by the organizer or the attendees of the requested meeting.

17. The method of claim 16, further comprising:
determining a distribution of weighted available meeting times for the organizer and each of the attendees based on one or more communications associated with the organizer and each of the attendees.

18. The method of claim 17, further comprising:
analyzing the one or more communications to determine a likelihood of attendance.

19. The method of claim 18, wherein the one or more communications include an email, a text message, a personal network posting, and a professional network posting.

20. The method of claim 16, further comprising:
determining a distribution of weighted available meeting times for the organizer and each of the attendees based on one or more one or more events on a schedule of the organizer and each of the attendees prior to and following a potential meeting time.
